(19) United States
(12) Patent Application Publication
(10) Pub. No.: US 2005/0227110 A1
(43) Pub. Date: Oct. 13, 2005

(54) Organic electroluminescent element

(76) Inventors: Shi-Hao Lee, Banciao City (TW); Wen-Kuen Chen, Jhubei City (TW); Chung-Wen Ko, Sijhih City (TW); Fan-Hsiu Chang, Miaoli City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/856,160

(22) Filed: May 28, 2004

(30) Foreign Application Priority Data
Apr. 8, 2004 (TW) 93109721

(51) Int. Cl. H05B 33/12

(52) U.S. Cl. 428/690; 428/917; 428/332; 313/504; 313/506

(57) ABSTRACT

An organic electroluminescent element having double mixed layers. The organic electroluminescent element comprises at least a substrate, a first electrode, a first type carrier transport mixed layer, a first type carrier transport layer, an emitting layer, and a second electrode. The structure of the organic electroluminescent element according to the present invention is designed in order to lowers the operating voltage and extends the lifetime thereof, and the electroluminescent interference problems of conventional organic electroluminescent elements are solved thereby.

### BACKGROUND OF THE INVENTION

1. Field of the Invention

The present invention relates to an organic electroluminescent element and, more particularly, to an organic electroluminescent element having double mixed layers.

2. Description of the Related Art

Recently, with the development and wide application of electronic products, such as mobile phones, PDA, and notebook computers, there has been increasing demand for flat display elements which consume less electric power and occupy less space. Among flat panel displays, organic electroluminescent elements are self-emitting, and highly luminous, with wider viewing angle, faster response speed, and a simple fabrication process, making them the display industry of choice.

Organic electroluminescent elements are classified as either tri-layer structured elements or bi-layer structured elements, depending on a combination of luminous and carrier transport layers.

A typical tri-layer structured element is known as a DH (double heterojunction) structured element and comprised of a hole transport layer, an emitting layer and an electron transport layer, bonded in that order. Typical bi-layer structured elements can be divided into SH-A (single heterojunction-A) structured element comprising a hole transport layers and an emitting layer, or SH-B (single heterojunction-B) structured element comprising a luminous layer and an electron transport layer.

As mentioned above, there are several types of organic electroluminescent elements, but all utilize the same emission principle. In organic electroluminescence, electrons are propelled from a cathode layer and holes from an anode layer, and the applied electric field induces a potential difference, such that the electrons and holes move and centralize in a thin film layer, resulting in luminescence through recombination thereof. The recombination takes place within the emitting layer at a region near the interface between the emitting layer and the carrier transport layer (i.e., the interface between the emitting layer and the hole transport layer or between the emitting layer and the electron transport layer).

Although the organic electroluminescent elements advantageously operate at a lower operating voltage compared to those in the initial stage of development, there are still some difficulties, such as high operating voltages and short lifetime, to be overcome to meet the demands of flat panel display makers.

In the structure of organic electroluminescent elements, heterojunction interfaces exist between the emitting layer and each carrier transport layer. In order to inject holes and electrons from their respective electrodes for recombination in the emitting layer, the carriers (electrons and holes) have to move across the heterojunction interfaces. When carriers move across such interfaces, however, they have to cross energy barriers of the interfaces. Therefore, as energy barriers become larger, the carrier movement between layers is less likely to occur, resulting in a higher operating voltage.

In general, the intent of lowering operating voltage is to improve the interface between the emitting layer and the carrier transport layer, such as a hole transport layer. Moreover, the hole transport materials used in the hole transporting zone of organic electroluminescent elements are the most vulnerable parts, susceptible to thermal degradation by physical aggregation or recrystallization.

Accordingly, an organic electroluminescent element having a hole transport layer of materials with high glass transition temperatures (Tg) has been developed to lower the operating voltage of the organic electroluminescent element and solve thermal degradation of the hole transport layer. However, since almost all reliable organic EL devices at present are fabricated with evaporative technology, improving device reliability by increasing Tg of holes transport materials has some limits. When Tg reaches a certain point, the molecular weight of an organic molecule may be so large that it is no longer sublimable or evaporatable.

An organic electroluminescent element with hole transport layer comprising two mixed hole transport materials has also been disclosed to lower the operating voltage. Referring to FIG. 1, the organic electroluminescent element 10 comprises a substrate 12, an anode electrode 14, a hole transport layer 16, an emitting layer 18, and a cathode 20, wherein the hole transport layer 16 comprises at least two mixed hole transport materials. However, since parts of electrons and holes are apt to recombine in the hole transport layer 16 near the interface 17 between the emitting layer 18 and the hole transport layer 16 at higher operating voltages, the hole transport layer 16 emits light through the dopant 19 resulting in luminescence interference.

Further improvements for organic electroluminescent elements are required in a variety of flat panel display applications. For instance, high performance and stability are essential to portable flat panel devices. Therefore, it is necessary to develop organic electroluminescent elements with low operating voltage, and extended lifetime in order to accommodate in to practical use.

### SUMMARY OF THE INVENTION

Accordingly, an object of the present invention is to provide an organic electroluminescent element having double mixed layers, to provide a low-resistance pathway for carriers movement between layers and increase element stability resulting from preventing lifetime limitations caused by carrier transport layers. The organic electroluminescent elements according to the present invention can replace conventional bi-layer or tri-layer structured organic electroluminescent elements and meet the demands of the flat panel display market, due to the low operating voltage, extended lifetime and high stability.

Another object of the present invention is to provide an organic electroluminescent element, solving the electroluminescent interference problems induced by recombinations in the hole transport layer for conventional organic electroluminescent elements.

To achieve the above objects, according to the present invention, an organic electroluminescent element having double mixed layers comprises a substrate, a first electrode, a first type carrier transport mixed layer, a first type carrier transport layer, an emitting layer, and a second electrode, wherein the first electrode, the first type carrier transport mixed layer, the first type carrier transport layer, the emitting layer, and the second electrode are formed on the substrate sequentially.

The first electrode can facilitate the first carrier injection, and the second electrode the second carrier injection. Moreover, at least one of the two electrodes is a transparent electrode. The first type carrier transport mixed layer, with a thickness between 100 Å˜1500 Å, comprises a first type carrier transport material and a first type carrier injection promoter, wherein the first type carrier injection promoter is doped into the first type carrier transport material to facilitate injection of the first type carriers into the first type carrier transport layer.

According to the present invention, the organic electroluminescent element can further comprise a second type carrier transport layer between the emitting layer and the second electrode.

The present invention also provides another organic electroluminescent element, comprising a substrate, an anode electrode, a hole transport mixed layer, a hole transport layer, an emitting layer, and a cathode electrode, wherein the anode electrode, the hole transport mixed layer, the hole transport layer, the emitting layer, and the cathode electrode are formed on the substrate sequentially.

According to the present invention, the organic electroluminescent element can further comprise an electron transport layer and/or electron injection layer between the emitting layer and the cathode electrode. As well, the organic electroluminescent element can further comprise a buffer layer between the anode electrode and the hole transport mixed layer.

In the present invention, the substrate employed in the organic electroluminescent element can be transparent or opaque. The organic electroluminescent element can be a bottom-emission, top-emission, or dual emission organic electroluminescent element.

According to the present invention, the structure of the organic electroluminescent element lowers the operating voltage and extends the lifetime thereof. The hole transport materials, hole injection promoters, light-emitting materials, and electroluminescent dopants employed in the present invention are unlimited, and can be the suitable materials used in photoelectric devices.

A detailed description is given in the following embodiments with reference to the accompanying drawings.

### BRIEF DESCRIPTION OF THE DRAWINGS

The present invention is more fully understood by reading the subsequent detailed description and examples with references made to the accompanying drawings, wherein:

FIG. 1 is a cross section of a conventional organic electroluminescent element.

FIG. 2 is a cross section of an organic electroluminescent element according to the present invention.

FIG. 3 is a cross section of an organic electroluminescent element according to another embodiment of the present invention.

FIG. 4 is a cross section of an organic electroluminescent element according to a first Working Example of the present invention.

FIG. 5 is a graph plotting operating voltage against current density of organic electroluminescent elements as disclosed in Working Example 1, Working Example 2, Comparative Example 1, and Comparative Example 2.

FIG. 6 is a graph plotting operating voltage against brightness of organic electroluminescent elements as disclosed in Working Example 1, Working Example 2, Comparative Example 1, and Comparative Example 2.

FIG. 7 is a graph plotting operating voltage against CIE chromaticity coordinates (X axis) of organic electroluminescent elements as disclosed in Working Example 1, Working Example 2, Comparative Example 1, and Comparative Example 2.

FIG. 8 is a graph plotting operating voltage against CIE chromaticity coordinates (Y axis) of organic electroluminescent elements as disclosed in Working Example 1, Working Example 2, Comparative Example 1, and Comparative Example 2.

FIG. 9 is a graph plotting lifetime of organic electroluminescent elements as disclosed in Working Example 1, Comparative Example 1, and Comparative Example 2.

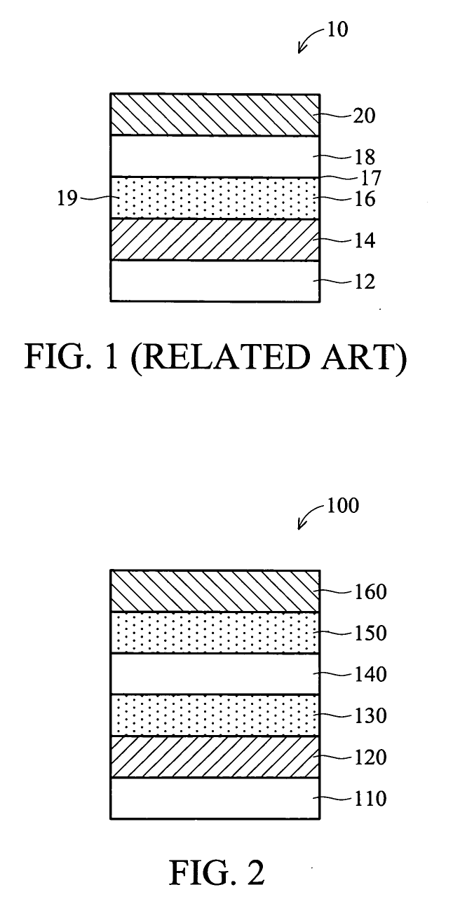

### DETAILED DESCRIPTION OF THE INVENTION

One feature of the present invention is use of a combination comprising a hole transport mixed layer, a doped emitting layer, and a hole transport layer formed between the two layers, resulting in lowered the operating voltage thereof and preventing luminescent interference from recombination in the hole transport layer. Referring to FIG. 2, the organic electroluminescent element 100 according to the present invention comprises at least a substrate 110, a first electrode 120, a first type carrier transport mixed layer 130, a first type carrier transport layer 140, an emitting layer 150, and a second electrode 160.

Moreover, the organic electroluminescent element 100 can further comprise a buffer layer formed between the first electrode 120 and the first type carrier transport mixed layer 130, and/or a second type carrier injection layer formed between the emitting layer 150 and the second electrode 160, wherein the second type carrier injection layer facilitates injection of the second type carriers into the emitting layer. In addition, a second type carrier transport layer can be further formed between the emitting layer 150 and the second type carrier injection layer.

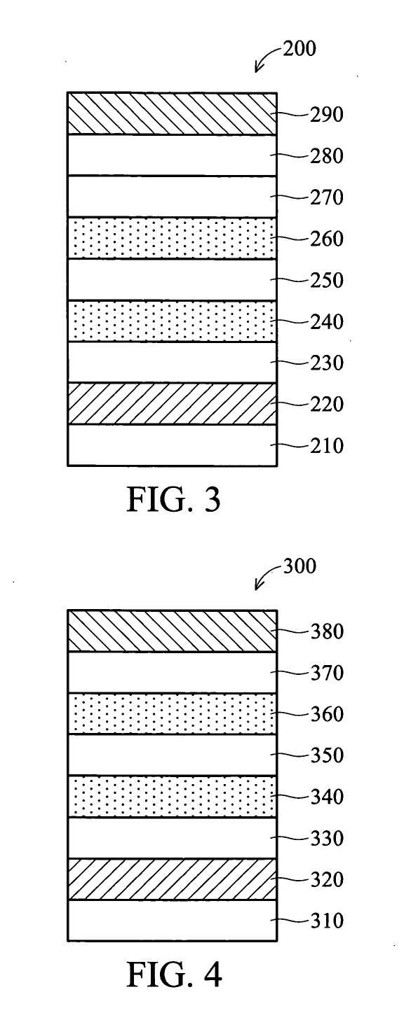

FIG. 3 is a cross section of an organic electroluminescent element according to another embodiment of the present invention, in which the first carriers are holes, and the second carriers are electrons. The method of fabricating the organic electroluminescent element 200 is described as following.

First, a substrate 210 is provided, wherein the substrate 210 is an insulating material such as glass, plastic, or ceramic. Next, a first electrode such as an anode electrode 220 is formed on the substrate 210. Suitable material for the anode electrode 220 is indium tin oxide (ITO), indium zinc oxide (IZO), aluminum zinc oxide (AZO), or zinc oxide (ZnO), and the anode electrode 220 can be formed by a method such as sputtering, electron beam evaporation, thermal evaporation, or chemical vapor deposition.

Subsequently, a buffer layer 230 is formed on the anode electrode 220, wherein materials for the buffer layer 230 can be suitable hole injection promotors. The buffer layer 230 formed on the anode electrode 220 improves the morphology of the anode electrode surface in order to prevent large leakage current and point discharge.

Subsequently, a first type carrier transport mixed layer, such as a hole transport mixed layer 240, is formed on the buffer layer 230. The hole transport mixed layer 240 comprises a hole transport material and a hole injection promoter, wherein the hole injection promoter is doped into the hole transport material to facilitate injection of holes. Herein, the choices of hole transport materials and hole injection promoters are unlimited, and those skilled in the art can optionally adjust the doped amount of the hole injection promoter according to the employed light-emitting materials and hole transport materials.

Subsequently, a first type carrier transport layer such as a hole transport layer 250 is formed on the hole transport mixed layer 240, wherein the hole transport layer comprises hole transport materials. According to the present invention, the hole transport material employed in the hole transport layer 250 and the hole transport mixed layer 240 can be the same or different. In some aspects, the hole transport layer 250 prevents electrons from recombining with the holes in the hole transport mixed layer 240, serving as an exciton block layer.

Subsequently, an emitting layer 260 is formed on the hole transport layer 250. The emitting layer comprises a light-emitting material and an electroluminescent dopant, wherein the electroluminescent dopant is doped into the light-emitting material and can perform energy transfer or carrier trapping under electron-holes recombination in the emitting layer. The light-emitting material can be fluorescent or phosphorescent materials. Herein, the choices of light-emitting materials and electroluminescent dopants are unlimited, and those skilled in the art can optionally adjust the doped amount of the electroluminescent dopants according to the employed light-emitting materials.

Subsequently, a second type carrier transport layer such as an electron transport layer 270 is formed on the emitting layer 260, wherein the electron transport layer comprises electron transport materials. In addition, a second type carrier injection layer such as an electron injection layer 280 further formed on the electron transport layer 270. According to the present invention, the buffer layer 230, the hole transport mixed layer 240, the hole transport layer 250, the emitting layer 260, the electron transport layer 270, and electron injection layer 280 can be formed by thermal vacuum evaporation.

Finally, a second electrode such as a cathode electrode 290 is formed on the electron injection layer 280, wherein the cathode electrode can be a transparent electrode or a metal electrode. The transparent electrode comprises ITO, IZO, AZO or ZnO, the metal electrode Li, Mg, Ca, Al, Ag, In, Au, Ni, Pt, or alloys thereof.

### WORKING EXAMPLE 1

As shown in FIG. 4, a thin film of indium tin oxide (ITO) 320, a buffer layer 330, a hole transport mixed layer 340, a hole transport layer 350, an emitting layer 360, an electron injection layer 370, and a aluminum electrode 380 were formed subsequently on a glass substrate 310 to obtain the organic electroluminescent element having double mixed layers 300. For purposes of clarity, the materials and layers formed therefrom are described as below.

The buffer layer 330, with a thickness of 600 Å, consisted of IDE406 (sold and manufactured by Idemitsu Co., Ltd.). The hole transport mixed layer 340, with a thickness of 300 Å, consisted of N,N′-di-1-naphthyl-N,N′-diphenyl-1,1′-biphenyl-1,1′-biphenyl-4,4′-diamine (NPB) as hole transport material and rubrene as hole injection promoter, wherein the dopant amount of rubrene was 15% by weight. The hole transport layer 350, with a thickness of 100 Å, consisted of NPB. The emitting layer 360, with a thickness of 300 Å, consisted of 10-(2-Benzothiazolyl)-2,3,6,7-tetrahydro-1,1,7,7-tetramethyl-1H,5H,11H-(1)-benzopyropyrano(6,7-8-i,j)quinolizin-11-one (C545T) as dopant, and NPB and tris(8-hydroxyquinoline) aluminum (Alq₃) as light-emitting materials, wherein the weight ratio between NBP and Alq₃ is 1:1 and the dopant amount of C545T was 1.1% by weight. The electron injection layer 370 consisted of lithium fluoride (LiF)

The structure of the organic electroluminescent element 300 can be represented as below:
ITO/IDE406 600 Å/NPB:Rubrene15% 300 Å/NPB 100 Å/(Alq₃:NPB=1:1):C545T1.1% 300 Å/Alq₃/LiF/Al

The measured results of optical properties for the organic electroluminescent element, as described in Working Example 1, are shown in Table 1.

TABLE 1
Optical Properties for Working Example 1

| | | | CIE | CIE | Peak |
|---|---|---|---|---|---|
| | Current | | chromaticity | chromaticity | Wave- |
| Voltage | Density | Brightness | coordinates | coordinates | length |
| (V) | (mA/cm²) | (cd/m²) | (X axis) | (X axis) | (nm) |
| 1 | 0 | 0 | 0 | 0 | 0 |
| 2 | 0 | 0 | 0 | 0 | 0 |
| 3 | 0.19 | 0 | 0 | 0 | 0 |
| 4 | 1.99 | 191.4 | 0.283 | 0.65 | 524 |
| 5 | 7.25 | 724.1 | 0.284 | 0.648 | 524 |
| 6 | 19.02 | 1909 | 0.284 | 0.647 | 524 |
| 7 | 42.38 | 4179 | 0.284 | 0.646 | 524 |
| 8 | 84.16 | 8304 | 0.284 | 0.645 | 524 |
| 9 | 162.5 | 16280 | 0.283 | 0.644 | 524 |
| 10 | 335.6 | overload | 0.283 | 0.644 | 524 |

Life time test for Working Example 1
(starting brightness (Lo): 2000 cd/m²)

| Time(hr) | L(measured brightness)/Lo |
|---|---|
| 0 | 1 |
| 15.73 | 0.96 |
| 30.57 | 0.92 |
| 45 | 0.93 |
| 67.9 | 0.92 |
| 95.6 | 0.89 |
| 130.6 | 0.87 |
| 147 | 0.86 |
| 186 | 0.84 |
| 240 | 0.83 |
| 282 | 0.82 |

### WORKING EXAMPLE 2

Example 2 was performed as Example 1 except for substitution of 30 wt % rubrene for 15 wt % rubrene. The structure of the organic electroluminescent element 300 can be represented as below:
ITO/IDE406 600 Å/NPB:Rubrene30% 300 Å/NPB 100 Å/(Alq₃:NPB=1:1):C545T1.1% 300 Å/Alq₃/LiF/Al

The measured results of optical properties for the organic electroluminescent element, as described in Working Example 2, are shown in Table 2.

TABLE 2
Optical Properties for Working Example 2

| | | | CIE | CIE | Peak |
|---|---|---|---|---|---|
| | Current | | chromaticity | chromaticity | Wave- |
| Voltage | Density | Brightness | coordinates | coordinates | length |
| (V) | (mA/cm²) | (cd/m²) | (X axis) | (X axis) | (nm) |
| 1 | 0 | 0 | 0 | 0 | 0 |
| 2 | 0 | 0 | 0 | 0 | 0 |
| 3 | 0.17 | 0 | 0 | 0 | 0 |
| 4 | 2 | 161.5 | 0.285 | 0.658 | 520 |
| 5 | 7.6 | 645.4 | 0.285 | 0.646 | 520 |
| 6 | 20.07 | 1735 | 0.285 | 0.645 | 520 |
| 7 | 43.99 | 3764 | 0.286 | 0.644 | 520 |
| 8 | 83.93 | 7149 | 0.285 | 0.644 | 520 |
| 9 | 162.8 | 15960 | 0.285 | 0.642 | 520 |
| 10 | 415.3 | overload | 0.285 | 0.642 | 520 |

### COMPARATIVE EXAMPLE 1

Comparative Example 1 was a bi-layer structured organic electroluminescent element with a mixed emitting layer and performed as Example 1 except for removal the hole transport mixed layer 340 and substitution of 400 Å hole transport layer 350 for 100 Å hole transport layer 350. The structure of the organic electroluminescent element can be represented as below:
ITO/IDE406 600 Å/NPB 400 Å/(Alq:NPB=1:1):C545T1.1% 300 Å/Alq/LiF/Al

The measured results of optical properties for the organic electroluminescent element, as described in Comparative Example 1, are shown in Table 3.

TABLE 3
Optical Properties for Comparative Example 1

| | | | CIE | CIE | Peak |
|---|---|---|---|---|---|
| | Current | | chromaticity | chromaticity | Wave- |
| Voltage | Density | Brightness | coordinates | coordinates | length |
| (V) | (mA/cm²) | (cd/m²) | (X axis) | (X axis) | (nm) |
| 1 | 0 | 0 | 0 | 0 | 0 |
| 2 | 0 | 0 | 0 | 0 | 0 |
| 3 | 0.01 | 0 | 0 | 0 | 0 |
| 4 | 1.44 | 172.5 | 0.261 | 0.674 | 528 |
| 5 | 4.65 | 575 | 0.262 | 0.673 | 528 |
| 6 | 10.85 | 1365 | 0.262 | 0.673 | 528 |
| 7 | 21.19 | 2667 | 0.263 | 0.672 | 528 |
| 8 | 38.57 | 5081 | 0.263 | 0.672 | 528 |
| 9 | 77 | 9684 | 0.263 | 0.671 | 528 |
| 10 | 121 | 16390 | 0.263 | 0.670 | 532 |

Life time test for Comparative Example 1
(starting brightness (Lo): 2000 cd/m²)

| Time(hr) | L(measured brightness)/Lo |
|---|---|
| 0 | 1 |
| 3.8 | 0.97 |
| 11.5 | 0.94 |
| 26.7 | 0.915 |
| 45.9 | 0.89 |
| 59 | 0.88 |
| 96.1 | 0.84 |
| 127.6 | 0.79 |
| 354 | 0.65 |

### COMPARATIVE EXAMPLE 2

Comparative Example 2 was a conventional tri-layer structured organic electroluminescent element with a doped emitting layer and performed as Comparative Example 1 except for substitution of the emitting layer consisted of Alq doped with 1.1% C545T for the emitting layer consisted of Alq and NBP (1:1) mixture doped with 1.1% C545T, and addition of a electron transport layer consisted of Alq, with a thickness of 300 Å, formed between the emitting layer 360 and the electron injection layer 370. The structure of the organic electroluminescent element can be represented as below:
ITO/IDE406 600 Å/NPB 400 Å/Alq:C545T1.1% 300 Å/Alq 300 Å/LiF/Al

The measured results of optical properties for organic electroluminescent element, as described in Comparative Example 2, are shown in Table 4.

TABLE 4
Optical Properties for Comparative Example 2

| | | | CIE | CIE | Peak |
|---|---|---|---|---|---|
| | Current | | chromaticity | chromaticity | Wave- |
| Voltage | Density | Brightness | coordinates | coordinates | length |
| (V) | (mA/cm²) | (cd/m²) | (X axis) | (Y axis) | (nm) |
| 1 | 0 | 0 | 0 | 0 | 0 |
| 2 | 0 | 0 | 0 | 0 | 0 |
| 3 | 0.04 | 0 | 0 | 0 | 0 |
| 4 | 0.61 | 68.6 | 0.325 | 0.636 | 524 |
| 5 | 2.84 | 326.4 | 0.325 | 0.636 | 524 |
| 6 | 8.58 | 998.8 | 0.325 | 0.636 | 524 |
| 7 | 21.3 | 2481 | 0.324 | 0.636 | 524 |
| 8 | 47.36 | 5481 | 0.324 | 0.636 | 528 |
| 9 | 98.3 | 11620 | 0.323 | 0.635 | 528 |
| 10 | 220.9 | 28130 | 0.322 | 0.635 | 524 |

Life time test for Comparative Example 2
(starting brightness (Lo): 2000 cd/m²)

| Time(hr) | L(measured brightness)/Lo |
|---|---|
| 0 | 1 |
| 69 | 0.6 |
| 79 | 0.59 |
| 117 | 0.52 |

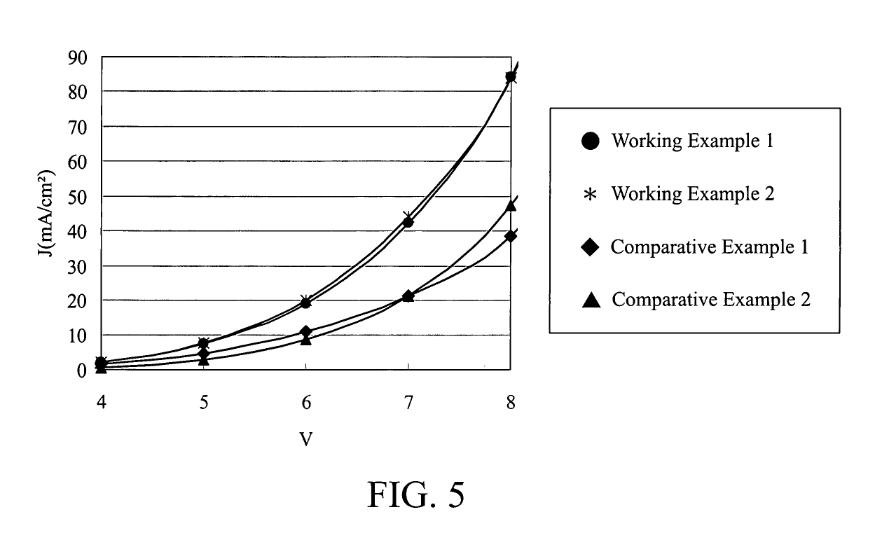

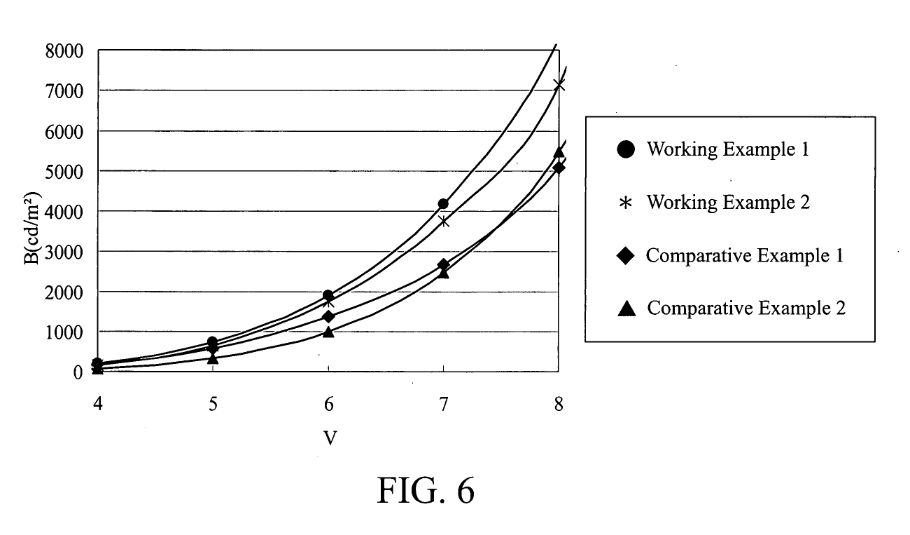

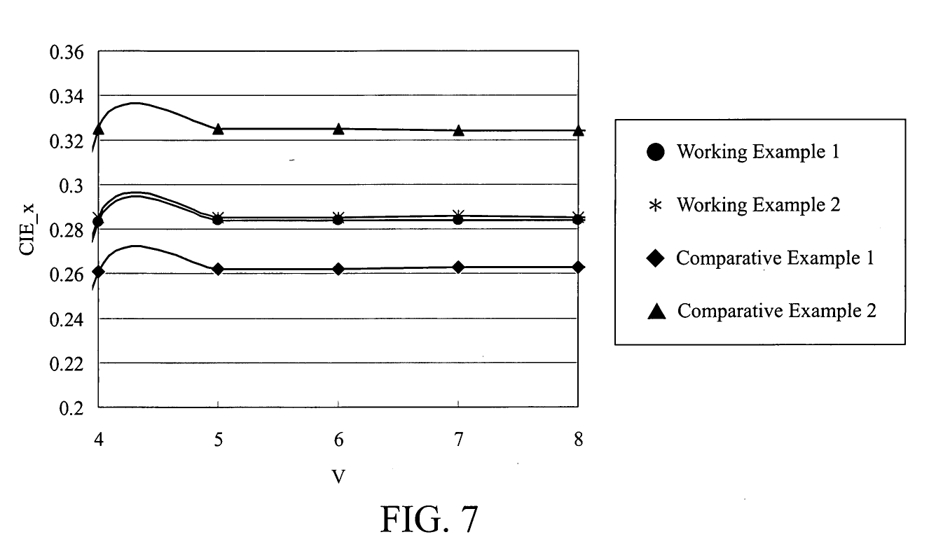

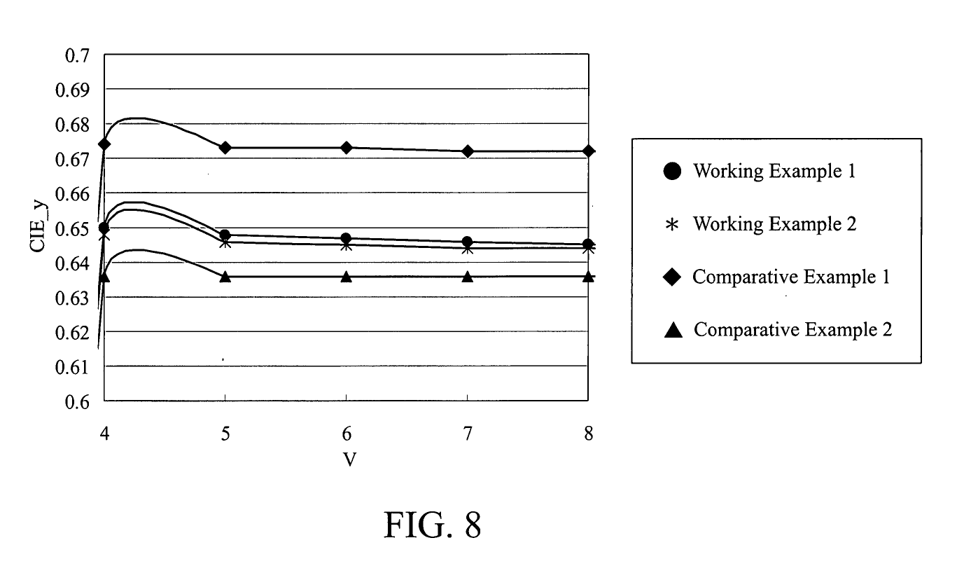

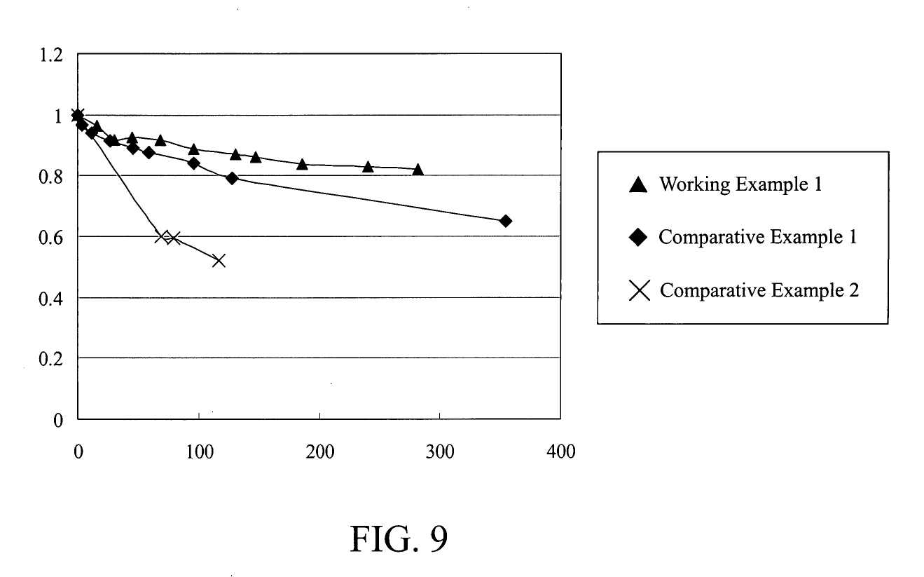

FIGS. 5˜9 also illustrate the differences between properties for the organic electroluminescent elements as described respectively in Working Example 1, Working Example 2, Comparative Example 1 and Comparative Example 2. Accordingly, the organic electroluminescent elements as disclosed in Working Examples 1 and 2 have lower operating voltages compared with the conventional organic electroluminescent elements as disclosed in Comparative Examples 1 and 2. Furthermore, referring to FIGS. 7 and 8, the emission chromaticity coordinates of elements, as disclosed in Working Examples 1 and 2, are almost invariable even through the operating voltage is increased to 10V. Moreover, lifetime thereof is also improved, as shown in FIG. 9.

In conclusion, the organic electroluminescent element according to the present invention comprises a first carrier transport layer, such as a hole transport layer, formed between a first carrier transport mixed layer, such as hole transport mixed layer, and a emitting layer. Since the first carriers injecting the emitting layer from the first electrode through not only the first carrier transport material, but also through the first type carrier injection promoters, the combination comprising the three layers reduces the resistance of pathway for first carriers, such as hole, injecting into the emitting layer. Therefore, the operating voltage of the organic electroluminescent element is thus significantly reduced, and lifetime limitations caused by hole transport layer are addressed in the present invention.

Moreover, since the first carrier transport mixed layer is formed by depositing two different materials, the morphology of the combination is improved thereby. Due to the reduced operating voltage and the improved morphology, the organic electroluminescent elements according to the present invention have extended lifetime, resulting in high element stability, to meet demands of flat panel displays market.

As well, since the hole transport layer is formed between the hole transport mixed layer and the emitting layer in the present invention, electroluminescent interference problems caused by conventional organic electroluminescent elements are solved thereby.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. An organic electroluminescent element, comprising:
a substrate;
a first electrode formed on the substrate;
a first type carrier transport mixed layer formed on the first electrode, wherein the first type carrier transport mixed layer comprises first type carrier transport materials and first type carrier injection promoters;
a first type carrier transport layer formed on the first type carrier transport mixed layer;
an emitting layer formed on the first type carrier transport layer, comprising light-emitting materials and dopants; and
a second electrode formed on the emitting layer.

2. The element as claimed in claim 1, further comprising a second type carrier transport layer formed between the emitting layer and the second electrode.

3. The element as claimed in claim 1, further comprising a buffer layer formed between the first electrode and the first type carrier transport mixed layer.

4. The element as claimed in claim 1, wherein the first type carrier transport layer comprises the same first type carrier transport material as the first type carrier transport mixed layer.

5. The element as claimed in claim 1, wherein the substrate is a glass substrate, a plastic substrate, a ceramic substrate or a silicon wafer.

6. The element as claimed in claim 1, wherein at least one of the first electrode and the second electrode is a transparent electrode.

7. The element as claimed in claim 3, wherein the first type carrier transport mixed layer has a thickness from 100 Å to 1500 Å.

8. An organic electroluminescent element, comprising:
a substrate;
an anode electrode formed on the substrate;
a hole transport mixed layer formed on the anode electrode, wherein the hole transport mixed layer comprises of hole transport materials and hole injection promoters;
a hole transport layer formed on the hole transport mixed layer;
an emitting layer formed on the hole transport layer, comprising light-emitting materials and dopants; and
a cathode electrode formed on the emitting layer.

9. The element as claimed in claim 8, further comprising a buffer layer formed between the anode electrode and the hole transport mixed layer.

10. The element as claimed in claim 8, further comprising an electron transport layer formed between the emitting layer and the cathode electrode.

11. The element as claimed in claim 9, further comprising an electron injection layer formed between the electron transport layer and the cathode electrode.

12. The element as claimed in claim 8, wherein the hole transport layer comprises the same hole transport material as the hole transport mixed layer.

13. The element as claimed in claim 8, wherein the substrate is a glass substrate, a plastic substrate, a ceramic substrate, or a silicon wafer.

14. The element as claimed in claim 8, wherein the hole transport mixed layer has a thickness from 100 Å to 1500 Å.

15. An organic electroluminescent element, comprising:
a substrate;
an anode electrode formed on the substrate;
a buffer layer formed on the anode electrode;
a hole transport mixed layer formed on the buffer layer, wherein the hole transport mixed layer is made of hole transport materials and hole injection promoters;
a hole transport layer formed on the hole transport mixed layer;
an emitting layer formed on the hole transport layer, comprising light-emitting materials and dopants;
an electron transport layer formed on the emitting layer; and
a cathode electrode formed on the electron transport layer.

16. The element as claimed in claim 15, further comprising an electron injection layer formed between the electron transport layer and the cathode electrode.

17. The element as claimed in claim 15, wherein the hole transport layer comprises the same hole transport material as the hole transport mixed layer.

18. The element as claimed in claim 15, wherein the substrate is a glass substrate, a plastic substrate, a ceramic substrate or a silicon wafer.

19. The element as claimed in claim 15, wherein the hole transport mixed layer has a thickness from 100 Å to 1500 Å.
